(19) United States
(12) Patent Application Publication
(10) Pub. No.: US 2004/0133456 A1
(43) Pub. Date: Jul. 8, 2004

(54) Method and apparatus for facilitating sales and management of aftermarket products

(76) Inventor: Mark Nagelvoort, Park Ridge, IL (US)

Correspondence Address: BUCKLEY, MASCHOFF, TALWALKAR LLC, 5 ELM STREET, NEW CANAAN, CT, 06840, US

(21) Appl. No.: 10/458,090

(22) Filed: Jun. 10, 2003

(51) Int. Cl. G06F 17/60

(52) U.S. Cl. 705/4

(57) ABSTRACT

Systems, methods, apparatus, computer program code, and means for integrating the sale of an aftermarket product to a customer with the sale of a vehicle to the customer include receiving sales information associated with the sale of the vehicle, where the sales information includes dealer information and vehicle information. An aftermarket product suitable for the customer is identified (based at least in part on the dealer information and the vehicle information). Aftermarket product terms are presented to the dealer, and an indication is received of the customer's desire to purchase the aftermarket product and the sale of the aftermarket product is completed.

### FIELD

Embodiments relate to methods and apparatus for facilitating sales. More particularly, embodiments relate to methods and apparatus for facilitating sales and management of aftermarket products.

### BACKGROUND

Automobile and other vehicle sales continue to be a large and important segment of the world economy. Most vehicles are sold by merchants referred to as automobile dealers (or automobile dealerships). These merchants specialize in selling new and used vehicles to customers. Automobile dealers also sell secondary products in conjunction with their sale of vehicles. For example, dealers often offer customers aftermarket products such as warranties, insurance, etc. Many of these aftermarket products are sold by the dealer as an agent (or on behalf of) third party vendors (e.g., such as an insurance company). Due to the relatively high income associated with the sale of vehicles, the primary focus of dealerships is the sale of vehicles. Sales of aftermarket products are secondary to this primary focus.

There have been many advances in automobile sales techniques and technologies. For example, many automobile dealerships utilize software programs to automate their inventory management and sales functions. These software programs are generally referred to as “dealer management systems”. These dealer management systems typically integrate a dealership's inventory management, sales, and accounting functions. In particular, these systems are designed and used to assist dealerships in the performance of their primary objective—selling vehicles to customers. Typical dealer management systems include those offered by ADP Dealer Services, Inc. and Reynolds & Reynolds (among others).

Existing dealer management systems make it difficult or inefficient for dealer representatives to offer and sell aftermarket products to consumers. For example, in a typical transaction at an automobile dealership, a sales representative completes much of the vehicle sales transaction with a customer. After the sales representative and the customer arrive at a general agreement regarding a particular vehicle and the vehicle's price, the customer is passed on to another dealer representative generally referred to as the “F&I” representative (where “F&I” generally refers to the “finance and insurance” department of the dealership). The F&I representative typically interacts with the dealership's dealer management system to generate final sales terms for the transaction. The system ensures that the dealership's inventory data and general ledger are updated to reflect the sale. The system may also be used to generate loan or lease documents to complete the transaction.

Often, the F&I representative is also encouraged (or even required) to offer aftermarket products to the customer. Unfortunately, the existing aftermarket sales process is inefficient and time consuming. In a typical aftermarket product sales transaction, the F&I representative consults a table of product information to select a product to offer the customer. Once the customer accepts the product, a product sales application is generated. The application is then transmitted to the aftermarket product vendor for approval. If the application is approved, a policy is issued and mailed to the customer. This process can take weeks to complete, and is subject to errors at each step.

For example, the F&I representative may mistakenly select the wrong product from the product table, causing the application to be rejected days, or even weeks after the application was prepared. As another example, some dealers may keep the money paid by customers for a product and then intentionally or inadvertently fail to mail in the application. This practice, referred to in the industry as “shrinkage”, can expose the customer to potential liability (e.g., for operating without insurance or without a warranty). The practice also results in a loss of revenue to the aftermarket product vendor. Further, the existing process does not allow a dealership to track its successes (and failures) in selling aftermarket products. Some F&I representatives may not actively (or appropriately) sell the appropriate aftermarket products, resulting in a loss of revenue to both the dealership and the aftermarket product vendors.

It would be desirable to provide improved systems and methods which address deficiencies in existing aftermarket product sales approaches. It would further be desirable to provide aftermarket product sales systems and methods which reduce inefficiencies, errors, and potential for fraud and other losses.

### SUMMARY

To alleviate problems inherent in the prior art, embodiments of the present invention provide systems, methods, apparatus, computer program code and means for facilitating the sale and management of aftermarket products.

Pursuant to some embodiments, systems, methods, apparatus, computer program code, and means for integrating the sale of an aftermarket product to a customer with the sale of a vehicle to the customer include receiving sales information associated with the sale of the vehicle, where the sales information includes dealer information and vehicle information. An aftermarket product suitable for the customer is identified (based at least in part on the dealer information and the vehicle information). Aftermarket product terms are presented to the dealer, and an indication is received of the customer's desire to purchase the aftermarket product and the sale of the aftermarket product is completed.

In some embodiments, the sales information is received from a dealer management system operated by the dealer and the aftermarket product terms are presented to the dealer via the dealer management system.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a transaction system consistent with embodiments of the present invention.

FIG. 2 is a block diagram of the aftermarket sales gateway of FIG. 1.

FIG. 3 is a flow diagram depicting a transaction process pursuant to some embodiments.

FIG. 4 is a flow diagram depicting a further transaction process pursuant to some embodiments.

FIG. 5 is a flow diagram depicting a cancellation process pursuant to some embodiments.

FIG. 6 is a flow diagram depicting a further transaction process pursuant to some embodiments.

FIG. 7 is a table depicting example aftermarket product pricing and eligibility rules.

### DETAILED DESCRIPTION

Applicant has recognized that there is a need for a system, method, apparatus, computer program code, and means for facilitating the sale and management of aftermarket products.

A number of terms are used herein. For example, as used herein, the terms “vehicle” or “automobile” are generally used to refer to a new or used automobile, truck, motorcycle, boat, or other vehicle sold or leased by a dealer to a customer. As used herein, the term “dealer” is generally used to refer to a merchant that is in the business of selling vehicles to customers. In some embodiments, the dealer is an automobile dealer or dealership which sells automobiles to customers. In some embodiments, the dealer has a physical retail presence. In some embodiments, the dealer sells products over the Internet. As used herein, the term “sale” or “sell” is used to generally refer to both vehicle or product sales as well as vehicle transfers by lease or other financing arrangements.

As used herein, the term “aftermarket product” is generally used to refer to a product that is complimentary to the sale or lease of a vehicle or which is purchased in conjunction with the sale or lease of a vehicle, or that is purchased to compliment a previously-acquired vehicle. For example, in an embodiment which will be discussed in detail herein, the aftermarket product is an automobile warranty or insurance policy that is purchased in conjunction with the sale or lease of an automobile. Other examples of aftermarket products which may be sold using embodiments of the present invention include: “Gap” insurance (covering any gap between an insurance company's payout and the actual retail value of a vehicle which is totaled), “MBI” insurance (extending the manufacturer's warranty on vehicles to a specific mileage or term), “VSCs” or “ESCs” (vehicle service contracts or extended service contracts), “etch” plans (a theft deterrent which involves placing traceable information onto the vehicle), etc.

As used herein, the term “aftermarket vendor” is generally used to refer to merchants that sell aftermarket products. For example, an automobile insurance company or an extended service provider both may be “aftermarket vendors”. Aftermarket vendors may also be referred to as “third party administrators” (TPAs). Other examples will be discussed in further detail below or will be apparent to those skilled in the art.

Transaction System

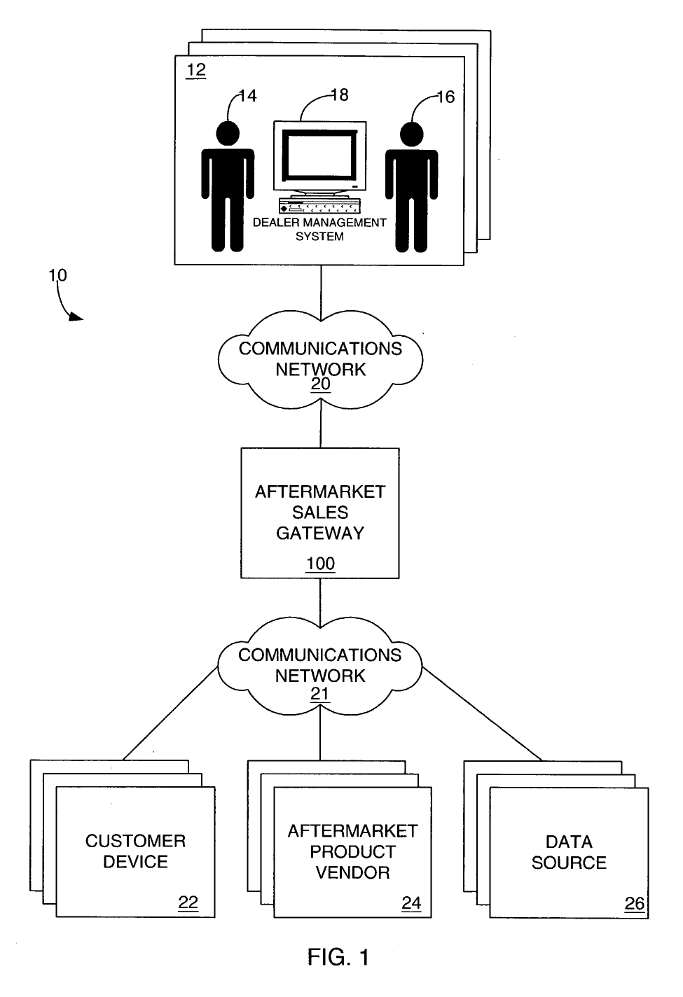

Features of embodiments will be described by first referring to FIG. 1 where a block diagram is shown depicting a transaction system 10. As shown, transaction system 10 includes a number of devices or entities in communication with each other. In particular, as depicted, transaction system 10 includes a dealer 12 operating a dealer management system 18 in communication with an aftermarket sales gateway 100 through a communications network 20. Aftermarket sales gateway 100 is further in communication with an aftermarket product vendor 24, data sources 26, and a customer device 22 through a communications network 21. In the embodiment shown, aftermarket sales gateway 100 is in communication with a number of dealers 12 (and dealer management systems 18), a number of customers operating customer devices 22, a number of aftermarket product vendors 24, and a number of data sources 26. In some embodiments, one or more gateway devices 100 may also be provided. For convenience, each of the devices or entities will generally be referred to in the singular throughout much of this description.

As shown, dealer 12 utilizes a dealer management system 18 to facilitate sales of vehicles. In general, dealer management systems include inventory, sales and accounting functions which allow a dealer representative 14 to complete a sale of a vehicle to a customer 16. A typical dealer management system 18 may operate in a networked environment at the dealer location. Dealer representative 14 may interact with dealer management system 18 through a series of user interfaces or screens which present the dealer representative 14 with information about the particular vehicle to be sold and information about the terms of the sale. Dealer representative 14 may be, for example, an individual in the dealer's finance and insurance (or “F&I”) department.

In some embodiments, dealer management system 18 is operated on a networked or stand-alone computer system (e.g., such as a personal computer or the like). In some embodiments, dealer management system 18 may by operated by a service provider and accessed by dealer representative 14 using client software operated on a terminal or computer at a dealer location. In either implementation, dealer management system 18 may be configured to interface with aftermarket sales gateway 100 through network 20. Further, in some embodiments, dealer management system 18 may interact directly with gateway 100. For example, in some embodiments, dealer management system 18 and aftermarket sales gateway 100 may be operated by the same entity (e.g., network 20 may be a direct connection rather than a network connection).

Pursuant to some embodiments, dealer management system 18 is in communication with aftermarket sales gateway 100 to receive aftermarket product information allowing dealer 12 to efficiently and accurately sell aftermarket products to customer 16. As will be described, in some embodiments, information from aftermarket sales gateway 100 is integrated into data screens of dealer management system 18, allowing dealer representative 16 to efficiently and accurately present aftermarket product sales information to customer 14 without needing to access other sales resources (e.g., the representative does not need to manually look up product information in a rate table or access a separate aftermarket product sales system to provide sales information to the customer). Further details of interaction between dealer 12 and aftermarket sales gateway 100 will be provided below.

Aftermarket sales gateway 100 also interacts with aftermarket product vendor 24 to receive detailed and timely product information. For example, aftermarket product vendor 24 may provide aftermarket sales gateway 100 with regular or periodic updates of product information, pricing data, and product eligibility requirements. As a specific example, if aftermarket product vendor 24 is a warranty service provider, it may provide aftermarket sales gateway 100 with its current “warranty wrap rates” and its current rules regarding vehicle make and model eligibility requirements. This information may be provided each time an update occurs or on a regular basis.

Aftermarket sales gateway 100 may provide information to aftermarket product vendor 24, including information about particular policies which have been issued by dealers through aftermarket sales gateway 100. This information may be provided substantially in real-time (e.g., each time a policy is issued for a product sold by an aftermarket vendor, the gateway may transmit a message providing details of the new policy to the vendor), or on a periodic basis (e.g., the gateway may collect information on policies issued on behalf of each vendor and then batch submit the information on a daily basis). In this manner, aftermarket sales gateway 100 may receive and maintain current product information for a number of aftermarket product vendors 24, and is able to quickly provide new policy information to those vendors.

Further, in some embodiments, aftermarket sales gateway 100 may interact with one or more customers operating customer devices 22 (e.g., to allow customers who have previously purchased vehicles to acquire aftermarket products associated with those vehicles and/or to allow customers to cancel existing aftermarket products). In some embodiments, aftermarket sales gateway 100 is also in communication with one or more data sources 26 which provide data to aftermarket sales gateway 100 which assists the gateway in providing accurate aftermarket product data to dealer 12. For example, data source 26 may be individual state or federal regulatory agencies which promulgate rules governing the sale or administration of automobile insurance or warranty products. Many states closely regulate the sales of these products. This regulatory data may be submitted to, or received by, gateway 100 to ensure that aftermarket products sold by dealers in different locations around the country (or around the world) are sold in compliance with different regulatory requirements of each location. In some embodiments, some or all of this regulatory data may be provided by aftermarket product vendor 24. By aggregating this regulatory and other data at aftermarket sales gateway 100, the gateway can accurately respond to product requests from dealers in many different regions.

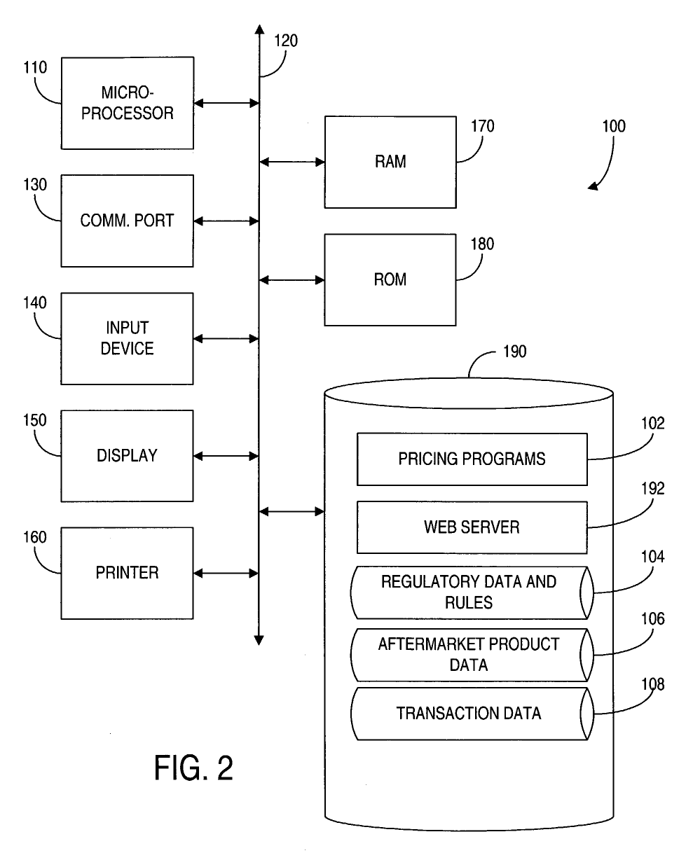

As used herein, devices (e.g., such as devices operated by or on behalf of individuals or entities to interact with aftermarket sales gateway 100 including customers, aftermarket product vendors, etc.) may be implemented using components capable of performing the various functions performed herein. For example, a dealer management system or customer device may be a computing device such as a personal computer (PC), a laptop computer, a hand-held computer, a telephone, or the like. Further details of one possible configuration of aftermarket sales gateway 100 will be described below in conjunction with FIG. 2. Other devices of system 10 may have similar configurations.

As used herein, some or all of the devices may communicate via one or more communications networks (e.g., such as networks 20, 21 of FIG. 1). For example, some or all of the devices may be in communication via an Internet Protocol (IP) network such as the Internet. Some or all of the devices may be in communication via other types of networks such as an intranet, a Local Area Network (LAN), a Metropolitan Area Network (MAN), a Wide Area Network (WAN), a proprietary network, a Public Switched Telephone Network (PSTN), and/or a wireless network.

According to some embodiments, communication between some or all of the devices of system 10 may be via a temporary computer communication channel (e.g., a logical path through which information may be exchanged). In other words, the communication channel between various devices may be established and discontinued as appropriate. For example, dealer management system 18 may exchange information with aftermarket sales gateway 100 only when communication is necessary to transmit (or receive) aftermarket product information. For example, an operator of dealer management system 18 may initiate communication with aftermarket sales gateway 100 by selecting a menu option which initiates a quote or other transaction involving aftermarket sales gateway 100.

According to some embodiments, some or all of the devices communicate with other devices via a public network. That is, at least a portion of the network may be accessed by devices other than the devices depicted in FIG. 1. In some embodiments, some or all of the information exchanged between devices of FIG. 1 may be encrypted or otherwise protected to prevent unauthorized third parties from accessing, manipulating, understanding, or otherwise misusing the information. In some embodiments, some or all of the devices may communicate via a private network.

Sales Gateway

Further details of one embodiment of aftermarket sales gateway will now be briefly discussed by referring to FIG. 2 where a block diagram of one embodiment of aftermarket sales gateway 100 is shown. As depicted, aftermarket sales gateway 100 is configured as a computing device programmed to operate pursuant to embodiments described herein. As depicted, aftermarket sales gateway 100 includes a microprocessor 110 coupled to a system bus 120 to interact with other components including a communications port 130, one or more input devices 140, output devices including a display 150 and a printer 160, and storage devices including RAM 170, ROM 180 and mass storage device 190.

Aftermarket sales gateway 100 may communicate with other devices (such as dealer management system 18, customer device 22, aftermarket product vendor 24, and data source 26) via communication port 130 coupled to networks 20, 21. Aftermarket sales gateway 100 may be configured as a Web server adapted to exchange information via the Internet or the like. According to some embodiments, gateway 100 communicates with other devices via a temporary computer communication channel (e.g., a path through which information can be exchanged). In other words, the communication channel between gateway 100 and another device (such as a dealer management system 18) may be established and discontinued as appropriate. Note that an established communication channel does not need to be associated with a particular physical path. For example, gateway 100 may exchange information with dealer management system 18 via a Web site, in which case packets of information may be transmitted via various physical paths.

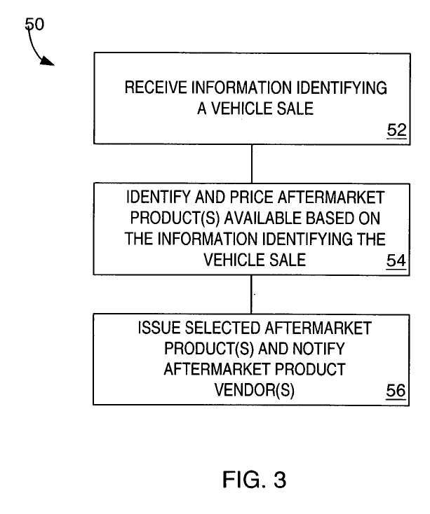

Mass storage device 190 of gateway 100 may store a number of different programs and data. For example, as shown, gateway 100 stores (or has access to) pricing programs 102 and Web server program 192 which cause gateway 100 to perform pricing and server functions. Data stored at (or accessible to) gateway 100 may include data such as regulatory data and rules 104 (which may include rules and data associated with different regulatory jurisdictions), aftermarket product data 106 (which may include product pricing and rules data received from one or more aftermarket product vendors) and transaction data 108 (which may include detailed transaction records for pending and issued transactions involving aftermarket products sold using gateway 100). Pricing programs 102 may be configured to facilitate a transaction process such as the transaction process 50 described in conjunction with FIG. 3, below.

Transaction Process

Reference is now made to FIG. 3 where a transaction process 50 pursuant to some embodiments is shown. In some embodiments, transaction process 50 may be performed under the control of aftermarket sales gateway 100. In some embodiments, some or all of the steps of transaction process 50 may be performed by other devices (e.g., such as dealer management system 18, etc.). The flow chart shown in FIG. 3 (and in the other figures described herein) do not imply a fixed order to the process flow. Embodiments can be practiced in any order that is practicable.

Transaction process 50 begins at 52 with receipt of information identifying a vehicle sale. In some embodiments, this information may be received directly from a dealer management system (e.g., such as dealer management system 18 of FIG. 1). For example, dealer management system 18 may cause a variety of information to be transmitted to aftermarket sales gateway 100 via network 20, including information identifying the dealer, information identifying the customer, and information identifying the specific vehicle for which an aftermarket product quote is desired. In some embodiments, the vehicle information received at 52 may be received from a customer operating a customer device 22 (e.g., in some embodiments, a customer who has purchased a vehicle may purchase an aftermarket product from an aftermarket vendor by interacting with sales gateway 100).

Processing continues at 54 where the system identifies and prices aftermarket product(s) available based on the information identifying the vehicle which was received at 52. For example, processing at 54 may involve parsing the information received at 52 and applying one or more rule sets to the information to determine which products are available for sale in conjunction with the vehicle sale. For example, as will be described further below, some products may not be available in certain jurisdictions, others may not be available before or after a particular date, still others may not be available for different types of vehicles. Processing at 54 may further involve comparing information received at 52 to one or more product databases to identify particular terms of available products. For example, aftermarket product vendors may provide pricing and eligibility tables to aftermarket sales gateway 100 to ensure the gateway maintains current pricing and eligibility data.

In some embodiments, information identifying aftermarket products which are identified at 54 may be presented to a dealer representative via a screen of dealer management system 18. The representative may then offer the product(s) to the customer. In some embodiments, the aftermarket product information may be presented directly to a customer such as a customer operating a customer device 22. For example, if several aftermarket products are available, the products may be presented in a menu fashion (e.g., allowing the customer or dealer to selectively view information about each product, including its price and other terms).

In either embodiment, if the customer agrees to purchase the aftermarket product(s), an acknowledgment message may be transmitted to the gateway 100 and processing continues at 56 where the system operates to issue the selected aftermarket product(s) and notify the aftermarket product vendor(s). For example, this may involve assigning a policy or account number to each of the issued aftermarket products and communicating the policy or account number to both the dealer (or directly to the customer) and the aftermarket product vendor along with details of the issued policy.

The dealer (or the customer) may utilize the policy number and the details of the issued policy to print or otherwise generate a copy of the policy documents for customer signature. A copy of the signed documents may then be transmitted to the aftermarket product vendor for its records. In this manner, a dealer may readily and efficiently integrate the sales of aftermarket products into a transaction involving the sale of a vehicle. Further, product rules and pricing data may be maintained up-to-date without need for the dealer to maintain or reference complicated rules and pricing data. In this manner, a large number and variety of different aftermarket products may be offered to dealers (and in turn to customers). Further, customers who wish to purchase aftermarket products for their vehicles may do so directly, in some embodiments, by interacting with sales gateway 100. Other features and advantages will become apparent to those skilled in the art upon reading this disclosure.

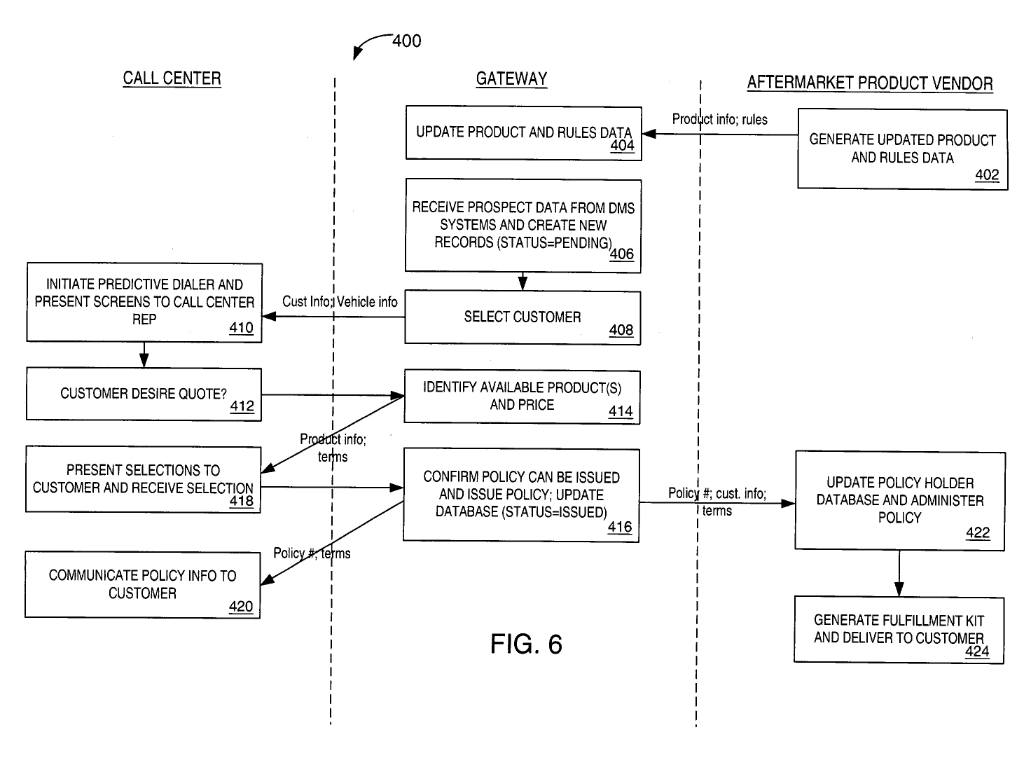

In some embodiments, the system may be operated to identify and track sales opportunities. For example, processing at 54 may identify one or more aftermarket products which are suitable for sale to a particular customer in connection with a particular vehicle. If the customer initially declines an offer to purchase one or more of these products, gateway 100 (and/or dealer management system 18) may store information associated with the identified products. This information may be used as the basis for follow-up sales activities. For example, the information may be used to drive a call center sales process (e.g., as described in conjunction with FIG. 6 below). In this manner, embodiments may be used to conduct sales of aftermarket products as well as to identify later sales opportunities.

Detailed Transaction Process

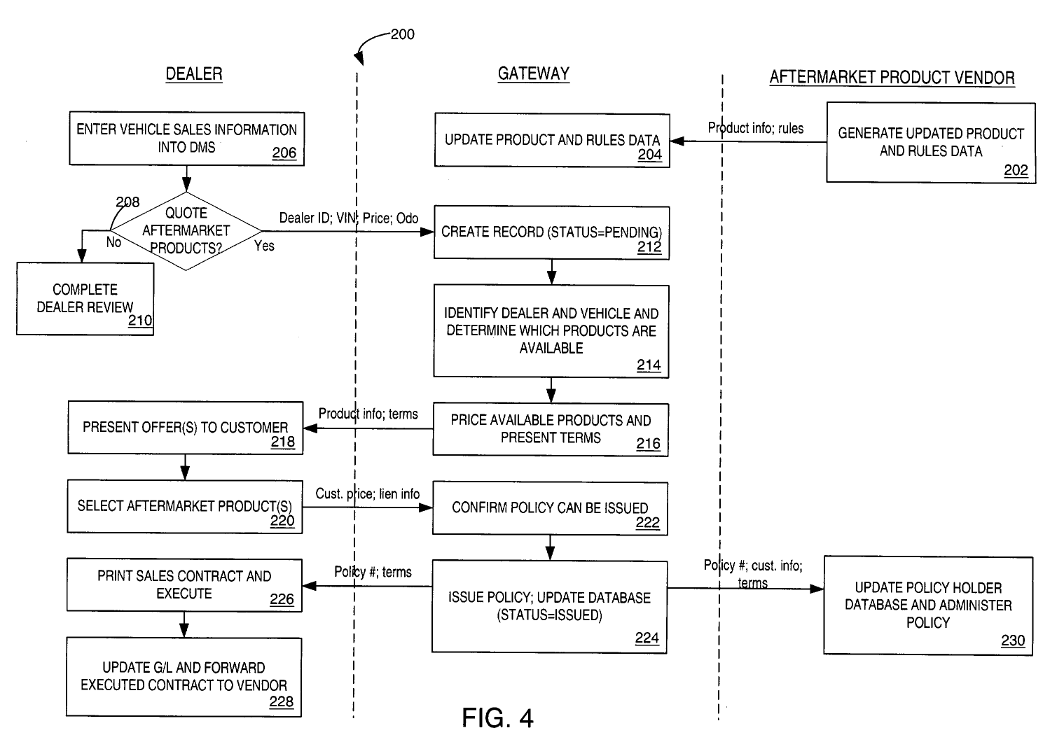

Reference is now made to FIG. 4, where a further transaction process 200 is shown pursuant to some embodiments. As shown, transaction process 200 includes interaction with several different parties: a dealer (e.g., operating dealer management system 18), a gateway (such as the aftermarket product gateway 100), and an aftermarket product vendor (e.g., operating a vendor device 24). As will become clear to those skilled in the art, not all of these parties need be involved in every transaction.

Process 200 begins at 202 where an aftermarket product vendor generates updated product and rules data. For example, the aftermarket product vendor may be a vendor that offers automobile insurance or warranty products. Typical aftermarket product vendors offer a variety of products. The pricing of, and eligibility for, each of these products typically varies based on a number of factors, such as: whether a vehicle is new or used, the vehicle mileage, whether the vehicle is under manufacturer warranty, the make and model of the vehicle, and the price of the vehicle. In some situations, the price and eligibility for different aftermarket products may also depend on information identifying the dealer (for example, some products may not be sold by certain dealers or in certain states). This information may be updated on a regular basis (and is not necessarily tied to any one transaction; updating of product information may be performed on a continuing basis to ensure that gateway 100 has up-to-date product pricing and eligibility information).

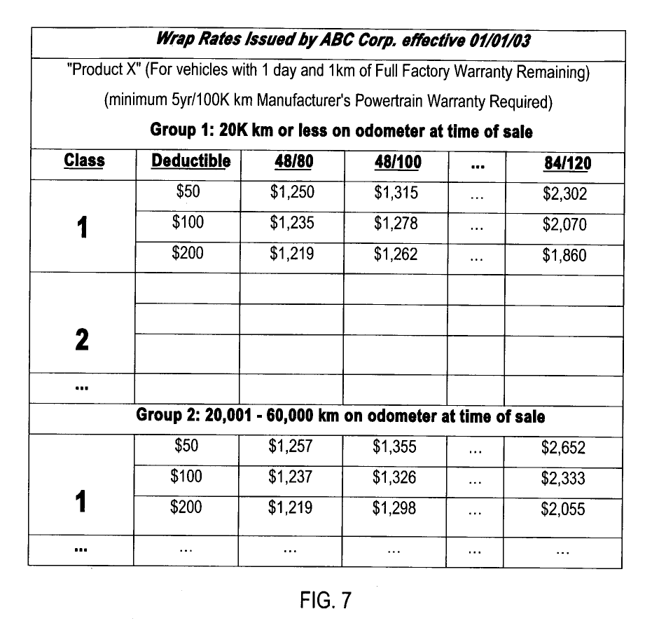

As a specific example, one type of an aftermarket product vendor is a warranty service provider. Warranty service providers periodically generate tables containing “warranty wrap rates”. An example warranty wrap rate table may be structured as shown in the example wrap rate table 500 of FIG. 7. As shown in the example table 500, a fictitious aftermarket product vendor “ABC Corp.” has published warranty wrap rates which are effective Jan. 1, 2003. The table provides rates for a particular product (referred to as “Product X”) which has a particular eligibility requirement (the product can only be sold for vehicles having 1 day and 1 km of full factory warranty remaining).

The table is broken into two sections for two different rate groups (Group 1 for vehicles having 20,000 or fewer kilometers on the odometer at the time of sale; Group 2 for vehicles having between 20,001 and 60,000 kilometers at the time of sale), and provides rates for different vehicle classes in three different deductibles ($50, $100, and $200). Columns of the table are broken into different product “bands” which are grouped based on the number of kilometers that the particular warranty product will apply (e.g., here, shown as a number such as 48/80 indicating a warranty up to 48,000/80,000 km for engine/powertrain). The price shown for each band at each deductible level are prices that the aftermarket product vendor will charge the dealer. The dealer may assess an additional charge to the customer for providing the aftermarket product. Those skilled in the art will recognize that vendors may utilize different groupings and criteria and that the rates, products and groupings of FIG. 7 are provided for illustrative purposes only.

Only several vehicle classes are shown in the example table of FIG. 7 (and illustrative prices are only shown for “Class 1” vehicles). A number of different classes may be specified by the aftermarket product vendor. The vendor may publish additional tables or rules which specify how different makes and models of vehicles are classified. Further, the vendor may also publish rules or tables which specify surcharges that may apply to certain vehicles (for example, a surcharge may be added for certain four wheel drive vehicles, for turbo- or super-charged vehicles, etc.), or which specify ineligible vehicles. Further still, different rate tables may be published for different geographical or regulatory regions (e.g., such as different U.S. states, different Canadian Provinces, etc). Each of these various tables and rules may be published or updated throughout the year by the aftermarket product vendor.

Referring again to FIG. 4, process 200 continues at 204 where the updated product and rules data are provided to gateway 100. In some embodiments, the product and rules data are provided over a network interface to gateway 100 (e.g., the data may be provided in XML formatted data packets over the Internet or via a direct connection). In some embodiments, the product and rules data is provided in other formats and are imported into databases associated with gateway 100.

Continuing the example introduced above, processing at 204 may include ABC Corp. transmitting data to gateway 100 which includes updated (or new) product rates (such as the data shown in table 700 of FIG. 7) and rule information. Gateway 100 updates databases with the updated product and rules data from the aftermarket product vendor. In some embodiments gateway 100 may receive product and rules updates from a number of different aftermarket product vendors (e.g., the processing at 204 may occur a number of different times as different vendors provide data to gateway 100). In some embodiments, each aftermarket product vendor may be associated with a unique identifier allowing data received from each vendor to be associated with the correct vendor.

Process 200 may continue at 206 when a sales representative of a dealer 12 enters vehicle sales information into dealer management system 18. Pursuant to some embodiments, dealer 12 is a dealer which has previously established an account or other business relationship with the entity operating gateway 100 (e.g., the dealer may have entered into an agreement with an entity operating gateway 100 that the dealer would utilize the services of gateway 100 to vend aftermarket products). Processing at 206 may be the normal processing of a dealership where a sales representative enters customer information, vehicle information and other information into dealer management system 18 in order to complete the sale of a vehicle to a customer.

In some embodiments, once sufficient vehicle sales information has been entered into dealer management system 18 (e.g., at the point where the vehicle sales transaction has is generally ready for final dealer review by the F&I department of the dealership), processing may continue at 208 where the F&I representative (or other representative of the dealer) selects a menu item of dealer management system 18 to initiate an aftermarket product “quote” process. If the representative or the customer determine that no aftermarket products should be quoted (e.g., where the customer is adamant that no quote be provided or where the representative determines that none should be sought), processing continues to 210 where the dealership completes its review of the vehicle sale.

If, however, an aftermarket product quote is sought, processing continues to 212 where information associated with the vehicle sale is transmitted to gateway 100. For example, in some embodiments, this information is automatically pulled from a record of information previously created in dealer management system 18. For example, the information may be retrieved from a database or cache of dealer management system 18, formatted into a message, and transmitted to aftermarket sales gateway 100 over communications network 20.

In some embodiments, the information is formatted into an “Extensible Markup Language” (XML) message format (or other format) which includes data identifying: the dealer (e.g., using a dealer identification number assigned to the dealer); the customer (e.g., including the customers name, address, and contact information); financing information (e.g., including information identifying any lienholder and finance company); and vehicle information (e.g., including a vehicle identification number or “VIN”, an odometer reading, and a vehicle sales price). In some embodiments, the message that is created and transmitted also includes security information such as, for example, a dealer password or other authentication information.

Upon receipt of the information, and upon identification of the dealer, gateway 100 creates a new transaction record associated with the vehicle purchase. In some embodiments, the new transaction record is assigned a status of “pending” and a transaction identifier is assigned to the record. The information associated with the vehicle purchase is stored in the record and identified by the newly assigned transaction identifier.

Processing continues at 214 where gateway 100 functions to identify the dealer and the vehicle and to determine which aftermarket products are available for the dealer and the vehicle. As discussed above, different aftermarket products may be available to different dealers and for different vehicles. Further, pricing associated with different products also depends on details of the transaction. Processing at 214 involves comparing details of the transaction to different product eligibility and pricing rules stored at (or accessible to) gateway 100. In particular, processing at 214 may involve comparing the transaction information to pricing data and rules such as the data and rules show in pricing table 700 received at 204. Because gateway 100 may have information associated with a large number of aftermarket vendors and a large number of aftermarket products (each potentially having complex eligibility and pricing rules), dealerships will now have access to a greater variety of products, allowing them to select products which more closely match their customer's needs. In some embodiments, information received at 212 is further analyzed to provide a more detailed identification of the dealer or the vehicle. For example, if the vehicle is identified by a VIN, the VIN may be used to identify the class, make, model, and model year of the vehicle.

In some embodiments, processing may include mapping the VIN to a vehicle code, which is then mapped to aftermarket product information. For example, RL Polk & Co., of Southfield, Mich., provides a tool to associate VIN information with vehicle codes. Embodiments described herein may additionally associate aftermarket product rating and pricing information with vehicle codes to allow aftermarket product vendors to price based on vehicle codes rather than pricing based on individual VIN codes (which change frequently).

Once appropriate aftermarket products (if any) are identified, processing continues at 216 where the available products are priced. For example, processing at 214 may find that several products are appropriate (e.g., such as the “48/80”, “48/100” and “84/120” aftermarket warranties for Class 1 vehicles shown in the table of FIG. 7). The pricing information identified at 216 may include a variety of prices (e.g., all three deductibles for all three aftermarket warranty variations may be identified) for a variety of different product options. This information is transmitted to dealer management system 18 so that the offer(s) may be presented to the customer at 218. In some embodiments, prior to presentation to the customer, the dealer F&I representative (or other operator of dealer management system 18) may determine which of the priced products to present to the customer. Further, the representative may determine that a dealer fee should be added to the price quoted by gateway 100. The price presented to the customer will generally include a dealer fee in addition to the product price quoted by gateway 100. In some embodiments, the information transmitted from gateway 100 to the dealer may be provided directly to dealer management system 18 in an XML formatted message (or other suitable message format).

In some embodiments, data from the message may be used to populate a quote screen displayed on a display device of dealer management system 18. The dealer representative may then communicate the product information to the customer. In some embodiments, deal management system 18 may automatically calculate the dealer fee which is to be added to the product price to arrive at a total product price to be offered to the customer.

Processing continues at 220 where the customer selects one or more aftermarket products to purchase. If needed, the dealer may negotiate the amount of the dealer fee. Further, in some embodiments, the dealership may offer to finance the total cost of the aftermarket product. The agreed-upon terms, including any financing information and the amount of the dealer fee, are entered into dealer management system 18 and are transmitted to gateway 100. The information transmitted to gateway 100 may also include the transaction identifier associated with the records established at 212 as well as a specific identification of the desired product and product terms.

Processing continues at 222 where gateway 100 confirms that the desired aftermarket product and terms can be issued. If a policy can be issued on the desired product, processing continues at 224 where gateway 100 causes a policy number to be issued. The transaction database (and the record associated with the particular transaction) is updated to change the status from “pending” to “issued” and the database is updated with the final transaction terms. Information is transmitted to dealer management system 18 including the newly-issued policy number and details of the policy. Dealer management system 18 may use this information to print a sales contract for execution by the customer. In this manner, the customer may receive confirmation and proof of issuance of a final, approved policy before (or in conjunction with) the completion of the purchase of the vehicle.

Gateway 100 also transmits information (including the newly-issued policy number and details of the policy) to the aftermarket product vendor associated with the policy. In some embodiments, this information is transmitted to the appropriate aftermarket product vendor in substantially real-time. In some embodiments, the information is transmitted on a regular basis (e.g., in a batch transmission) or as-needed. In this manner, aftermarket product vendors are timely notified of the issuance of new policies, and may promptly update their policy holder databases and take steps to appropriately administer issued policies.

Processing at the dealership may further include prompt and accurate updating of the dealerships accounts payable, accounts receivable and other general ledger information. The dealership may also cause a copy of the executed policy agreement to be transmitted to the aftermarket vendor. By allowing prompt and confirmed issuance of aftermarket policies and products, the dealership can accurately track income associated with the sale of aftermarket products. In some embodiments, information may be tracked to determine which sales representatives are successful (or unsuccessful) in selling aftermarket products. Commissions may be accurately paid and tracked based on individual performance. Further, dealerships may “net pay” aftermarket product vendors. For example, if a dealership issues 10 policies on behalf of ABC Corp. in a month, but cancels one policy, the total amount to be remitted to ABC Corp. may be accurately calculated and paid in a net total for the month.

In some situations, processing may reach step 218 and the customer may decline to purchase any of the aftermarket products. In some embodiments, dealer management system 18 may transmit a “decline” message to gateway 100. Gateway 100 will update a status of the record associated with the transaction to indicate that the policy was not issued. In some embodiments, the record may be maintained as pending (e.g., the record will not be closed out) so that the dealer or the customer may reestablish contact with gateway 100 and resume the purchase of the aftermarket products.

Cancellation Process

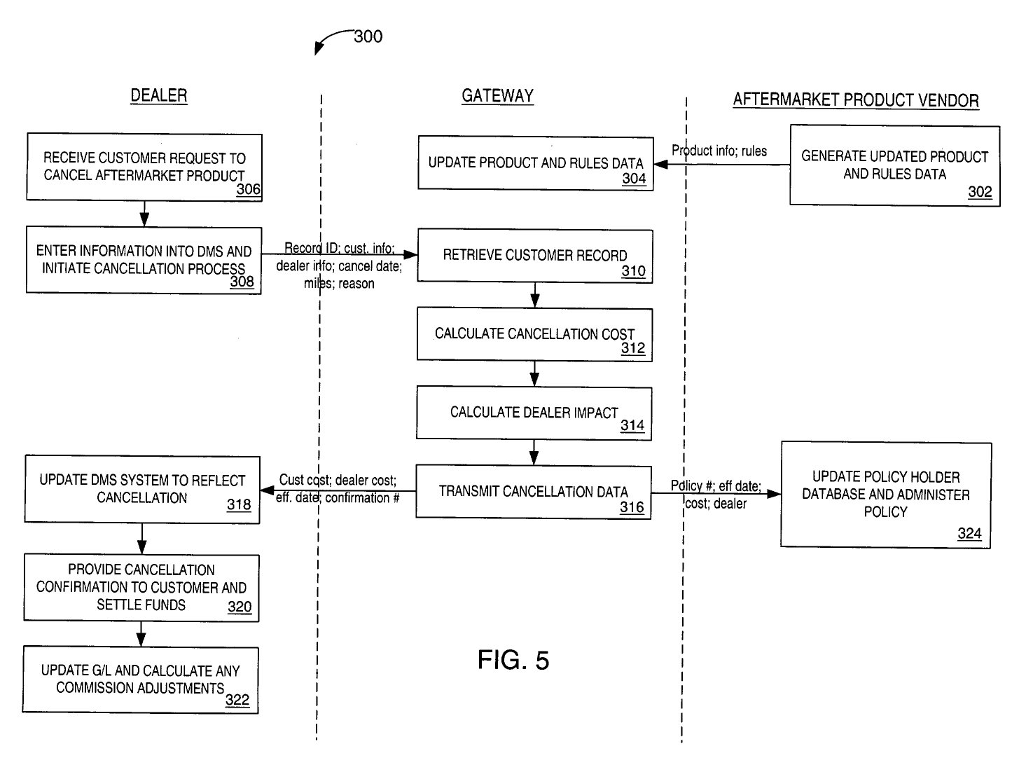

Reference is now made to FIG. 5, where a cancellation process 300 pursuant to some embodiments is shown. As with the process of FIG. 4, cancellation process 300 includes several participants at various points in the overall process, including a dealer (e.g., operating dealer management system 18), gateway 100, and one or more aftermarket product vendors (e.g., operating aftermarket product vendor devices 24). As with the process of FIG. 4, aftermarket product vendors provide gateway 100 with product and rules information.

A particular cancellation transaction begins at 306 when the dealer receives a customer request to cancel an aftermarket product prior to the natural expiration date of the product. As a particular example, assume that a customer purchased an extended warranty which was intended to last for 50,000 miles or 2 years and the customer decides to cancel the extended warranty while time still remains on the warranty. Pursuant to embodiments of the present invention, the customer may now cancel the product by interacting with the dealer.

Processing continues at 308 where a dealer representative, operating dealer management system 18, enters information regarding the customer, the vehicle or the policy number, and initiates the cancellation process. Information associated with the policy is transmitted (e.g., via an XML message or using other message formats) to gateway 100. In some embodiments, the message transmitted to gateway 100 includes a record number or other identifier associated with the policy, customer information, dealer information, a cancellation date, the vehicle mileage, and a reason for the cancellation.

Processing continues at 310 where gateway 100 utilizes this information to retrieve the transaction record associated with the policy. Based on the received information and the transaction record, processing continues at 312 where gateway 100 calculates a cancellation cost for the early cancellation. Different state and federal regulatory authorities may impose different requirements on early cancellations of aftermarket products (including different pricing rules for cancellations). Processing at 312 may include identifying the applicable rules and applying those rules to the information associated with the cancellation request and the transaction record to calculate the appropriate cancellation cost. In some situations (e.g., where the dealer financed some or all of the product cost, etc.) gateway 100 may also perform processing at 314 to calculate a total dealer cost impact. Once the cancellation costs to the customer and to the dealer are identified, processing continues at 316 where this information is transmitted to the dealer management system 18. The effective date of the cancellation as well as a confirmation number may also be transmitted.

Processing continues at 318 where dealer management system 18 is updated to reflect the cancellation. For example, the general ledger of the dealership may be updated to record the dealer cost and to remove any future projected receivables associated with the policy. Processing continues at 320 where information is provided to the customer regarding the cancellation. For example, dealer management system 18 may cause a confirmation record to be printed for the customer's signature. Further, any customer cost of cancellation will be communicated to the customer. The customer may remit funds to cover the customer's cost of cancellation to the dealership. In some situations, the dealership may then remit funds to the aftermarket product vendor. As described above in conjunction with FIG. 4, embodiments allow the dealership to “net pay” aftermarket product vendors. Any cancellation costs owed to an aftermarket product vendor may be included in a monthly or other periodic net payment to the vendor. Processing at 322 may cause this information to be recorded in the dealership's accounting systems. Further, in some situations, a dealership may cause sales commissions to be adjusted to reflect the cancellation.

Processing at 324 includes the transmission or communication of cancellation information to the aftermarket product vendor which issued the policy to be cancelled. Information may be transmitted in substantially real time or it may be batch transmitted or otherwise communicated to the vendor. The information transmitted to the vendor may include information identifying the policy number, the effective date of the cancellation, the costs associated with the cancellation (e.g., the customer cost to be remitted to the vendor), and information identifying the dealer. In this manner, vendors may maintain accurate and up-to-date records regarding their policies and their cancellations. Further, customers are provided with an efficient and reliable means of cancelling aftermarket products, and dealerships are provided with a mechanism for quickly and accurately identifying cancellation costs associated with such cancellations.

Call Center Transaction Process

A further transaction process 400 will now be described by reference to FIG. 6. In particular, FIG. 6 depicts a process for purchasing aftermarket products in a call center environment. In some embodiments, process 400 may be performed after an initial quote process has been performed (e.g., after a customer declined to purchase any aftermarket products in the process 200 of FIG. 4). For example, process 400 may be a process which is performed on behalf of a number of different dealerships in an attempt to sell aftermarket products to recent customers of the dealerships (particularly where the customers did not purchase aftermarket products in connection with the original purchase of a vehicle, although the process 400 may also be used to sell additional aftermarket products to customers).

As with processes 200 and 300, process 400 includes the transfer of updated product and rules data from aftermarket product vendors to gateway 100. Process 400 begins at 406 where gateway 100 receives prospect data from dealer systems and creates new records associated with each of the prospects. For example, the prospect data may include customer transaction records from dealer management system 18 including information identifying the customer, the dealer, and a particular vehicle purchased from the dealer. In some embodiments, this information may be transmitted from dealer management system 18 to gateway 100 in an XML formatted message on a regular or periodic basis. The information received at 406 may include a large number of records, each associated with a particular customer and a particular vehicle.

Processing continues at 408 where gateway 100 selects a customer (or a group of customers) to contact. Upon selection of a customer, information identifying the customer and the particular vehicle purchased by the customer may be transferred to a call center and used to initiate a predictive dialer and to populate a display screen used by a customer service representative. Sales scripts may be presented to the customer service representative prompting the representative to inquire whether the customer desires a quote for an aftermarket product which may be purchased for the vehicle. If the customer agrees to receive a quote, the call center representative may initiate a quote request. If the customer declines to receive a quote, the processing may terminate and gateway 100 may update its information indicating that the customer has declined a quotation.

Processing continues at 414 where gateway 414 identifies available aftermarket products and prices. Processing at 414 is generally performed in a similar manner as processing of process 200 of FIG. 4 (particularly steps 212-216). Aftermarket products and their prices are transmitted to the call center for presentation to the customer at 418. The information may be displayed to a call center representative on a display screen so that the representative may read the actual product quotes and offers to the customer. The customer's selection (or declination) of the products is communicated to the representative who keys the selection (or declination) information into an operator terminal and transmits the information to gateway 100 at 416. Processing at 416 may include closing the record if the customer declines all products. If the customer accepts an aftermarket product offer, processing at 416 may include updating the database record from “pending” to “issued” and assigning a policy number to the issued policy. This information may be communicated to the call center for presentation to the customer as well as to the aftermarket product vendor so that the vendor can update its policyholder database and take steps to administer the policy. In some embodiments, the aftermarket product vendor generates a fulfillment kit and delivers it to the customer.

In this manner, customers who either were not presented with aftermarket product quotes at the time of purchasing a vehicle (or who declined to purchase an aftermarket product at the time of purchasing the vehicle) may be presented with aftermarket product offers using features of embodiments of the present invention.

Although the present invention has been described with respect to example embodiments, those skilled in the art will note that various substitutions may be made to those embodiments described herein without departing from the spirit and scope of the present invention. For example, while embodiments have been discussed relating to the use of gateway 100 to issue and cancel policies, embodiments may also be utilized to track claims made by customers who have policies which were issued using gateway 100. For example, dealer management system 18 may interact with gateway 100 to approve (or decline) a customer claim. If a claim is approved, gateway 100 may update information in its databases and also notify the appropriate aftermarket product vendor of the claim. Other features will be apparent to those skilled in the art.

What is claimed is:

1. A method for integrating the sale of an aftermarket product to a customer with the sale of a vehicle to the customer, comprising:
receiving, from a dealer, sales information associated with the sale of the vehicle, the sales information including dealer information and vehicle information;
identifying, based at least in part on the dealer information and the vehicle information, an aftermarket product suitable for said customer;
causing aftermarket product terms to be presented to said dealer;
receiving, from said dealer, an indication of the customer's desire to purchase said aftermarket product; and
completing the sale of said aftermarket product.

2. The method of claim 1, wherein said sales information is received from a dealer management system operated by said dealer and said aftermarket product terms are presented to said dealer using said dealer management system.

3. The method of claim 1, wherein said completing the sale of said aftermarket product includes:
transmitting aftermarket product data to said dealer; and
causing generation of a signature-ready purchase agreement between said customer and a vendor of said aftermarket product.

4. The method of claim 1, wherein said completing the sale of said aftermarket product includes:
transmitting information associated with said sale of said aftermarket product to a vendor of said aftermarket product.

5. The method of claim 1, wherein said identifying an aftermarket product suitable for the customer further includes:
determining, based at least in part on said dealer information, that said aftermarket product is available for sale by said dealer; and
determining, based at least in part on said vehicle information, that said aftermarket product is available for sale in association with the vehicle.

6. The method of claim 5, wherein said determining, based at least in part on said dealer information, further comprises:
comparing a location of said dealer with information identifying aftermarket products available in the location.

7. The method of claim 5, wherein said determining, based at least in part on said dealer information, further comprises:
comparing an identity of said dealer with information identifying aftermarket products available to said dealer.

8. The method of claim 5, wherein said determining, based at least in part on said vehicle information, further comprises:
comparing a sales price of the vehicle to information identifying aftermarket products available for vehicles of said sales price.

9. The method of claim 5, wherein said determining, based at least in part on said vehicle information, further comprises:
identifying a make and a model of the vehicle; and
comparing said make and said model to information identifying aftermarket products available for vehicles having said make and said model.

10. The method of claim 5, wherein said determining, based at least in part on said vehicle information, further comprises:
identifying a mileage of the vehicle; and
comparing said mileage to information identifying aftermarket products available for vehicles having said mileage.

11. The method of claim 5, further comprising:
determining, based at least in part on a date of the sale, that said aftermarket product is available for sale on the date.

12. The method of claim 1 further comprising:
generating a database record associated with said sales information received from said dealer.

13. The method of claim 12, further comprising:
assigning a deal identifier to said database record; and
assigning a status identifier to said database record indicating a status of at least one of pending and issued.

14. The method of claim 12, further comprising:
capturing information associated with said transaction including information identifying a cancellation of said sale of said aftermarket product.

15. The method of claim 1, wherein said receiving an indication of the customer's desire to purchase further comprises:
receiving information identifying a price said customer agrees to pay; and
receiving information identifying a lien holder associated with said aftermarket product.

16. The method of claim 1, wherein said identifying an aftermarket product further comprises identifying a plurality of aftermarket products and wherein said receiving an indication of the customer's desire further comprises receiving a selection of at least one of said aftermarket products.

17. The method of claim 1, wherein said completing the sale further comprises causing a general ledger of said dealer to be updated with information associated with said sale of said aftermarket product.

18. The method of claim 12, further comprising:
assigning a policy identifier to said database record in connection with completing the sale of said aftermarket product.

19. An aftermarket sales system, comprising:
a processor; and
a storage device in communication with said processor and storing instructions adapted to be executed by said processor to
receive sales information associated with the sale of a vehicle by a dealer, the sales information including dealer information and vehicle information;
identify, based at least in part on the dealer information and the vehicle information, an aftermarket product suitable for association with said sale;
receive an indication of the customer's desire to purchase said aftermarket product; and
complete the sale of said aftermarket product.

20. A method for operating a dealer management system, comprising:
transmitting an aftermarket product quote request, said quote request including information identifying a dealer and information identifying a vehicle purchase;
receiving an aftermarket product offer including price information associated with an aftermarket product suitable for sale with said vehicle purchase;
transmitting an acceptance of said aftermarket product offer;
receiving aftermarket product information; and
causing an aftermarket product agreement to be generated having said aftermarket product information.

21. A method for canceling an aftermarket product policy, comprising:
receiving a cancellation request including information specifying a policy number, dealer information, and a cancellation date;
identifying an aftermarket product policy sales record associated with said policy number;
calculating a customer cancellation cost;
calculating a dealer cancellation impact; and
transmitting a cancellation message to said dealer and to an aftermarket product vendor, said cancellation message including said dealer cancellation impact and said customer cancellation cost.
